(19) United States
(12) Patent Application Publication
(10) Pub. No.: US 2026/0214227 A1
(43) Pub. Date: Jul. 23, 2026

(54) VIDEO ENCODER, VIDEO ENCODING METHOD, VIDEO DECODER, VIDEO DECODING METHOD

(71) Applicant: GUANGDONG OPPO MOBILE TELECOMMUNICATIONS CORP., LTD., Guangdong (CN)

(72) Inventors: Jonathan GAN, Ryde (AU); Yue YU, Palo Alto, CA (US); Haoping YU, Palo Alto, CA (US)

(73) Assignee: GUANGDONG OPPO MOBILE TELECOMMUNICATIONS CORP., LTD., Guangdong (CN)

(21) Appl. No.: 19/139,187

(22) PCT Filed: Nov. 24, 2023
(86) PCT No.: PCT/US2023/081029

§ 371 Date: Jun. 13, 2025

Related U.S. Application Data
(60) Provisional application No. 63/387,497, filed on Dec. 14, 2022.

(51) Int. Cl. H04N 19/122; H04N 19/159; H04N 19/176; H04N 19/196; H04N 19/61

(52) U.S. Cl. CPC H04N 19/122; H04N 19/159; H04N 19/176; H04N 19/196; H04N 19/61

(57) ABSTRACT

The video encoding method, the video decoding method, the video encoder and the video decoder are provided. The video decoder includes an entropy decoding module, a prediction module, an inverse quantization module, an inverse transform module and a reconstruction module. The entropy decoding module receives an input bitstream. The prediction module determines a prediction block. The entropy decoding module decodes the input bitstream to obtain a plurality of quantized coefficients and a NSPT index. The inverse quantization module inversely quantizes the quantized coefficients to generate a plurality of reconstructed coefficients. In response to a current coding block (CB) having 8×16, 16×8 or 16×16 block size, the inverse transform module executes an inverse non-separable primary transform (NSPT) on the reconstructed coefficients to generate a reconstructed residual block based on a kernel. The reconstruction module generates a reconstructed CB according to the reconstructed residual block and the prediction block.

### CROSS-REFERENCE TO RELATED APPLICATION

This application claims the priority benefit of U.S. provisional application Ser. No. 63/387,497, filed on Dec. 14, 2022. The entirety of the above-mentioned patent application is hereby incorporated by reference herein and made a part of this specification.

### TECHNICAL FIELD

The present invention relates to the field of image data processing, and specifically, to a video encoding method, a video decoding method, a video encoder, and a video decoder.

### RELATED ART

In traditional image coding technology, how to predict and compress data efficiently has always been an important topic in this field. In particular, new transform methods (i.e., non-separable primary transforms) are able to efficiently compress data for small coding blocks, but are computationally expensive to apply to large coding blocks.

### SUMMARY OF INVENTION

### Technical Problem

A novel image processing method for efficiently encoding the video data and efficiently decoding the corresponding bitstream are desirable.

### Solution to Problem

The video encoder of the invention includes a partition module, a prediction module, an arithmetic module, a transform module, a quantization module and an entropy coding module. The partition module is configured to receive an input video and generate a plurality of coding blocks (CBs) of the input video. The prediction module is coupled to the partition module, and configured to generate a prediction block of a current CB. The arithmetic module is coupled to the partition module and the prediction module, and configured to calculate a residual block according to the current CB and the prediction block. The transform module is coupled to the arithmetic module, and in response to the residual block having 8×16 block size, 16×8 block size or 16×16 block size, and a determined NSPT index having value 1, 2, or 3, the transform module is configured to execute a non-separable primary transform (NSPT) on the residual block to generate a plurality of coefficients based on a kernel. The quantization module is coupled to the transform module, and configured to quantize the plurality of coefficients to generate a plurality of quantized coefficients. The entropy coding module is coupled to the quantization module, and configured to encode the plurality of quantized coefficients to an output bitstream. The entropy coding module is configured to encode the NSPT index to the output bitstream.

In an embodiment of the invention, the partition module is configured to divide an input picture of the input video into a plurality of coding tree units (CTUs), and partition each CTU into one or more coding units (CUs) to generate a plurality of CUs and equivalently the plurality of coding blocks (CBs).

In an embodiment of the invention, the prediction module is configured to generate the prediction block of the current CB by an intra prediction.

In an embodiment of the invention, in response to the residual block having 8×16 block size, the transform module executes a NSPT using a NSPT transform matrix selected from a kernel with dimensionality 128×B1×C×D. The parameter B1 is a number of transform coefficients produced by the NSPT from an encoder perspective, the parameter C is 3, and the parameter D is 35.

In an embodiment of the invention, in response to the residual block having 16×8 block size, the transform module executes a NSPT using a NSPT transform matrix selected from a kernel with dimensionality 128×B1×C×D. The parameter B1 is a number of transform coefficients produced by the NSPT from an encoder perspective, the parameter C is 3, and the parameter D is 35.

In an embodiment of the invention, in response to the residual block having 16×16 block size, the transform module executes a NSPT using a NSPT transform matrix selected from a kernel with dimensionality 256×B2×C×D. The parameter B2 is a number of transform coefficients produced by the NSPT from an encoder perspective, the parameter C is 3, and the parameter D is 35.

In an embodiment of the invention, the parameter B1 and the parameter B2 are 32.

In an embodiment of the invention, the parameter B1 and the parameter B2 are close to but not equal to 32.

In an embodiment of the invention, the prediction module further executes a zero-out on the residual block, so that the residual block after zero-out has a zero-out region.

In an embodiment of the invention, in response to a size of the residual block being larger than a block size supported by a largest NSPT kernel, the transform module is further configured to partition the residual block into a plurality of smaller transform blocks.

In an embodiment of the invention, a NSPT index is signalled for each transform block in the plurality of smaller transform blocks.

In an embodiment of the invention, a NSPT index is signalled for each unique transform block size, the transform blocks in the plurality of smaller transform blocks with same block size sharing a common NSPT index.

In an embodiment of the invention, in response to a size of the residual block being larger than a block size supported by the largest NSPT kernel, the current CB is implicitly split into a plurality of smaller prediction blocks before prediction.

The video encoding method of the invention includes the following steps: receiving an input video and generate a plurality of coding blocks (CBs) of the input video; generating a prediction block of a current CB; calculating a residual block according to the current CB and the prediction block; in response to the residual block having 8×16 block size, 16×8 block size or 16×16 block size, and a determined NSPT index having value 1, 2, or 3, executing a non-separable primary transform (NSPT) on the residual block to generate a plurality of coefficients based on a kernel; quantizing the plurality of coefficients to generate a plurality of quantized coefficients; encoding the plurality of quantized coefficients through entropy coding to an output bitstream; and encoding the NSPT index to the output bitstream.

In an embodiment of the invention, the video encoding method further includes the following steps: dividing an input picture of the input video into a plurality of coding tree units (CTUs); and partitioning each CTUs into one or more CUs to generate a plurality of CUs and equivalently a plurality of coding blocks (CBs).

In an embodiment of the invention, the prediction block of current CB is generated by an intra prediction.

In an embodiment of the invention, in response to the residual block having 8×16 block size, the video encoding method executes a NSPT using a NSPT transform matrix selected from a kernel with dimensionality 128×B1×C×D. The parameter B1 is a number of transform coefficients produced by the NSPT from an encoder perspective, the parameter C is 3, and the parameter D is 35.

In an embodiment of the invention, in response to the residual block having 16×8 block size, the video encoding method executes a NSPT using a NSPT transform matrix selected from a kernel with dimensionality 128×B1×C×D. The parameter B1 is a number of transform coefficients produced by the NSPT from an encoder perspective, the parameter C is 3, and the parameter D is 35.

In an embodiment of the invention, in response to the residual block having 16×16 block size, the video encoding method executes a NSPT using a NSPT transform matrix selected from a kernel with dimensionality 256×B2×C×D. The parameter B2 is a number of transform coefficients produced by the NSPT from an encoder perspective, the parameter C is 3, and the parameter D is 35.

In an embodiment of the invention, the parameter B1 and the parameter B2 are 32.

In an embodiment of the invention, the parameter B1 and the parameter B2 are close to but not equal to 32.

In an embodiment of the invention, the video encoding method further includes the following steps: executing zero-out on the residual block, so that the residual block after zero-out has a zero-out region.

In an embodiment of the invention, the video encoding method further includes the following steps: in response to a size of the residual block being larger than a block size supported by a largest NSPT kernel, partitioning the residual block into a plurality of smaller transform blocks.

In an embodiment of the invention, a NSPT index is signalled for each transform block in the plurality of smaller transform blocks.

In an embodiment of the invention, a NSPT index is signalled for each unique transform block size, the transform blocks in the plurality of smaller transform blocks with same block size sharing a common NSPT index.

In an embodiment of the invention, the video encoding method further includes the following steps: in response to a size of the plurality of residual blocks being larger than a block size supported by the largest NSPT kernel, the current CB is implicitly split into a plurality of smaller prediction blocks before prediction.

The video decoder of the invention includes an entropy decoding module, a prediction module, an inverse quantization module, an inverse transform module and a reconstruction module. The entropy decoding module is configured to receive an input bitstream. The prediction module is coupled to the entropy decoding module, and configured to determine a prediction block. The entropy decoding module is configured to decode the input bitstream to obtain a plurality of quantized coefficients and a NSPT index. The inverse quantization module is coupled to the entropy decoding module, and configured to inversely quantize the plurality of quantized coefficients to generate a plurality of reconstructed coefficients. The inverse transform module is coupled to the inverse quantization module, and in response to a current coding block (CB) having 8×16 block size, 16×8 block size or 16×16 block size, and the NSPT index having value 1, 2, or 3, the inverse transform module is configured to execute an inverse non-separable primary transform (NSPT) on the plurality of reconstructed coefficients to generate a reconstructed residual block based on a kernel. The reconstruction module is coupled to the prediction module and the inverse transform module, and configured to generate a reconstructed CB according to the reconstructed residual block and the prediction block.

In an embodiment of the invention, the reconstruction module is configured to combine the reconstructed CB with a plurality of reconstructed CBs to generate the output video.

In an embodiment of the invention, in response to a flag or set of flags indicating application of an intra prediction, the prediction module is configured to determine the prediction block of the current CB by intra prediction.

In an embodiment of the invention, in response to the current CB having 8×16 block size, the inverse transform module executes an inverse NSPT using a NSPT transform matrix selected from a kernel with dimensionality 128×B1×C×D. The parameter B1 is a number of transform coefficients produced by the NSPT from an encoder perspective, the parameter C is 3, and the parameter D is 35.

In an embodiment of the invention, in response to the current CB having 16×8 block size, the inverse transform module executes an inverse NSPT using a NSPT transform matrix selected from a kernel with dimensionality 128×B1×C×D. The parameter B1 is a number of transform coefficients produced by the NSPT from an encoder perspective, the parameter C is 3, and the parameter D is 35.

In an embodiment of the invention, in response to the current CB having 16×16 block size, the inverse transform module executes an inverse NSPT using a NSPT transform matrix selected from a kernel with dimensionality 256×B2×C×D. The parameter B2 is a number of transform coefficients produced by the NSPT from an encoder perspective, the parameter C is 3, and the parameter D is 35.

In an embodiment of the invention, the parameter B1 and the parameter B2 are 32.

In an embodiment of the invention, the parameter B1 and the parameter B2 are close to but not equal to 32.

The video decoding method of the invention includes the following steps: receiving an input bitstream; determining a prediction block according to the input bitstream; entropy decoding the input bitstream to obtain a plurality of quantized coefficients and a NSPT index; inversely quantizing the plurality of quantized coefficients to generate a plurality of reconstructed coefficients; in response to a current coding block (CB) having 8×16 block size, 16×8 block size or 16×16 block size, and the NSPT index having value 1, 2, or 3, executing an inverse non-separable primary transform (NSPT) on the plurality of reconstructed coefficients to generate a reconstructed residual block based on a kernel; and generating a reconstructed CB according to the residual block and the prediction block.

In an embodiment of the invention, the video decoding method further includes the following steps: combining the reconstructed CB with a plurality of reconstructed CBs to generate the output video.

In an embodiment of the invention, in response to a flag or set of flags indicating application of an intra prediction, the prediction block of the current CB is determined by intra prediction.

In an embodiment of the invention, in response to the current CB having 8×16 block size, the video decoding method executes an inverse NSPT using a NSPT transform matrix selected from a kernel with dimensionality 128×B1×C×D. The parameter B1 is a number of transform coefficients produced by the NSPT from an encoder perspective, the parameter C is 3, and the parameter D is 35.

In an embodiment of the invention, in response to the current CB having 16×8 block size, the video decoding method executes an inverse NSPT using a NSPT transform matrix selected from a kernel with dimensionality 128×B1×C×D. The parameter B1 is a number of transform coefficients produced by the NSPT from an encoder perspective, the parameter C is 3, and the parameter D is 35.

In an embodiment of the invention, in response to the current CB having 16×16 block size, the video decoding method executes an inverse NSPT using a NSPT transform matrix selected from a kernel with dimensionality 256×B2×C×D. The parameter B2 is a number of transform coefficients produced by the NSPT from an encoder perspective, the parameter C is 3, and the parameter D is 35.

In an embodiment of the invention, the parameter B1 and the parameter B2 are 32.

In an embodiment of the invention, the parameter B1 and the parameter B2 are close to but not equal to 32.

### Effects of Invention

Based on the above, according to the video encoding method, the video decoding method, the video encoder, and the video decoder of the invention can effectively improve coding performance for video coding.

To make the aforementioned more comprehensible, several embodiments accompanied with drawings are described in detail as follows.

### BRIEF DESCRIPTION OF DRAWINGS

FIG. 1 is a schematic diagram of a video encoder according to an embodiment of the invention.

FIG. 2 is a schematic diagram of a video encoding process according to an embodiment of the invention.

FIG. 3 is a flowchart of a video encoding method according to an embodiment of the invention.

FIG. 4 is a schematic diagram of a picture divided into a plurality of blocks according to an embodiment of the invention.

FIG. 5 is a schematic diagram of a CTU divided into a plurality of CUs according to an embodiment of the invention.

FIG. 6A is a schematic diagram of LFNST for 4×N and N×4 block sizes according to an embodiment of the invention.

FIG. 6B is a schematic diagram of LFNST for large block sizes according to an embodiment of the invention.

FIG. 7A is a schematic diagram of LFNST for 4×N and N×4 block sizes according to an embodiment of the invention.

FIG. 7B is a schematic diagram of LFNST for 8×N and N×8 block sizes according to an embodiment of the invention.

FIG. 7C is a schematic diagram of LFNST for 16×N and N×16 block sizes according to an embodiment of the invention.

FIG. 8 is a schematic diagram of a zero-out region according to an embodiment of the invention.

FIG. 9A is a schematic diagram of splitting a residual block according to an embodiment of the invention.

FIG. 9B is a schematic diagram of splitting a residual block according to another embodiment of the invention.

FIG. 10 is a schematic diagram of local prediction according to another embodiment of the invention.

FIG. 11 is a schematic diagram of a video decoder according to an embodiment of the invention.

FIG. 12 is a schematic diagram of a video decoding process according to an embodiment of the invention.

FIG. 13 is a flowchart of a video decoding method according to an embodiment of the invention.

### DESCRIPTION OF EMBODIMENTS

In order to have a more detailed understanding of the characteristics and technical content of the embodiments of the present application, the implementation of the embodiments of the present application will be described in detail below with reference to the accompanying drawings. The attached drawings are for reference and explanation purposes only and are not used to limit the embodiments of the present application.

Modern international video coding standards typically describe block-based hybrid methods for decoding bitstreams. For example, the High Efficiency Video Coding (HEVC) and Versatile Video Coding (VVC) standards are block-based hybrid spatial and temporal predictive coding schemes. That is, to produce such bitstreams when encoding each picture, the picture is partitioned into a quantity of blocks and then each of these blocks is encoded.

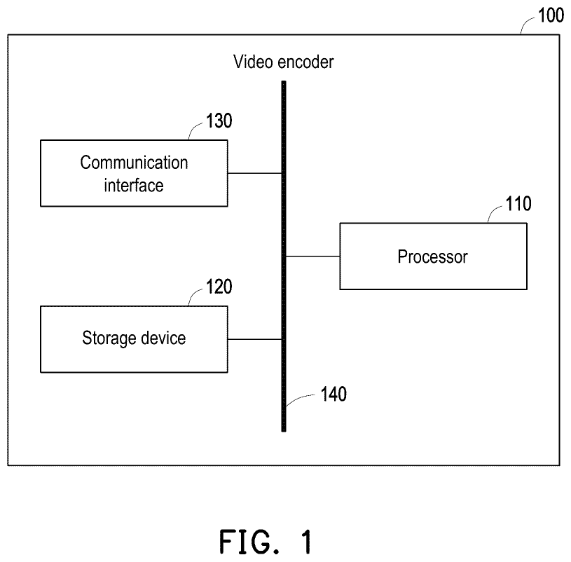

FIG. 1 is a schematic diagram of a video encoder according to an embodiment of the invention. Referring to FIG. 1, the video encoder 100 includes a processor 110, a storage device 120, a communication interface 130, and a data bus 140. The processor 110 is electrically connected to the storage device 120, the communication interface 130 through the data bus 140.

In the embodiment of the invention, the storage device 120 may store relevant instructions, and may further store relevant video encoders of algorithms. The processor 110 may output a bitstream to the communication interface 130. The processor 110 may execute the relevant instructions to implement video coding methods of the invention.

In one embodiment of the invention, the video encoder 100 may be implemented by one or more personal computer (PC), one or more server computer, and one or more workstation computer or composed of multiple computing devices, but the invention is not limited thereto. In another embodiment of the invention, the video encoder 100 may include more processors for executing the relevant video encoders and/or the relevant instructions to implement the video encoding method of the invention. In addition, in one embodiment of the invention, the video encoder 100 may include more processors for executing the relevant video encoders, the relevant video decoders and/or the relevant instructions to implement the video encoding method of the invention. The video encoder 100 may be used to implement a video codec, and can perform a video encoding function and a video decoding function in the invention.

In one embodiment of the invention, the processor 110 may include, for example, a central processing unit (CPU), a graphic processing unit (GPU), or other programmable general-purpose or special-purpose microprocessor, digital signal processor (DSP), application specific integrated circuit (ASIC), programmable logic device (PLD), other similar processing circuits or a combination of these devices. In one embodiment of the invention, the storage device 120 may be a non-transitory computer-readable recording medium, such as a read-only memory (ROM), an erasable programmable read-only memory (EPROM), an electrically-erasable programmable read-only memory (EEPROM) or a non-volatile memory (NVM), but the present invention is not limited thereto.

In one embodiment of the invention, the relevant video encoders and/or the relevant instructions may also be stored in the non-transitory computer-readable recording medium of one apparatus, and executed by the processor of another apparatus. The communication interface 130 may, for example, be a network card that supports wired network connections such as Ethernet, a wireless network card that supports wireless communication standards such as Institute of Electrical and Electronics Engineers (IEEE) 802.11n/b/g/ac/ax/be, or any other network connecting device, but the embodiment is not limited thereto. The communication interface 130 is configured to retrieve an input video.

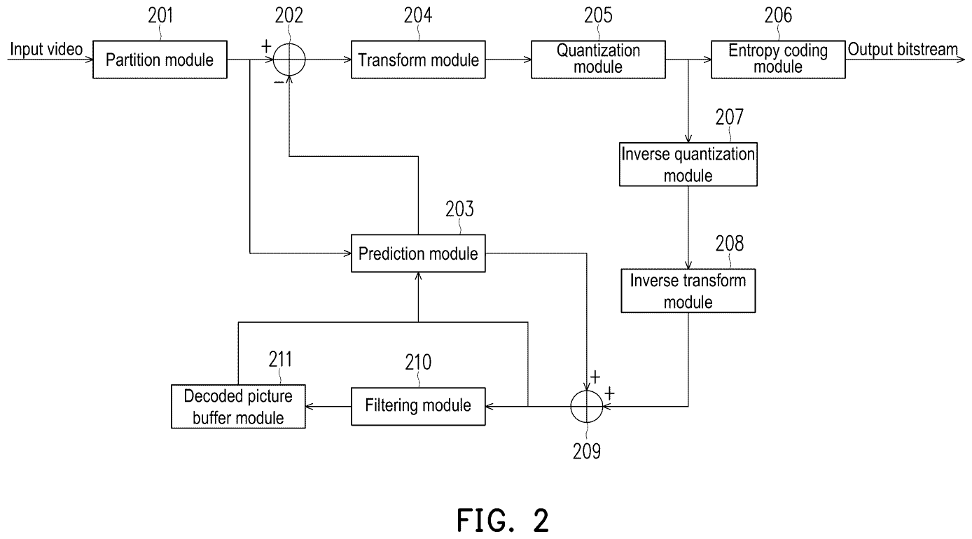

FIG. 2 is a schematic diagram of a video encoding process according to an embodiment of the invention. Referring to FIG. 1 and FIG. 2, the video encoder 100 may encode the input video to the output bitstream by performing the video encoding process of FIG. 2. The storage device 120 may store algorithms of a partition module 201, an arithmetic module 202 (e.g. adder module or subtraction module), a prediction module 203, a transform module 204, a quantization module 205, an entropy coding module 206, an inverse quantization module 207, an inverse transform module 208, a reconstruction module 209 (e.g. adder module or subtraction module), a filtering module 210 and a decoded picture buffer module 211. The processor 110 may execute the above modules to perform the video encoding process.

In one embodiment of the invention, the processor 110 may receive an input video from an external video source. The partition module 201 may receive the input video and partition each picture of the input video into a plurality of coding tree units (CTUs) and partition each CTU into one or more CUs to generate a plurality of coding units (CUs). Each CU consists of one or more spatially co-located coding blocks (CB), where each coding block corresponds to a colour component of the video. Therefore, the partition module 201 equivalently generates a plurality of coding blocks (CBs). The prediction module 203 may receive a current CB, and perform an intra prediction to generate a prediction block of the current CB, but the invention is not limited thereto. The prediction module 203 may alternatively perform an inter prediction, a motion prediction and/or other prediction to generate a prediction block of the current CB. The arithmetic module 202 may receive the current CB and the prediction block, and execute subtraction operation on the current CB and the prediction block to generate a residual block.

The transform module 204 may execute a non-separable primary transform (NSPT) on the residual block based on a (NSPT) kernel, transforming the data of the residual block to generate a plurality of coefficients. The transform module 204 may alternatively execute other transforms, such as a Karhunen-Loeve Transform (KLT), a two-dimensional discrete cosine transform (DCT), and/or a low frequency non-separable secondary transform (LFNST). The quantization module 205 may further quantize the plurality of coefficients to generate a plurality of quantized coefficients. The entropy coding module 206 may then encode the plurality of quantized coefficients to generate an output bitstream. The entropy coding module 206 may firstly binarize the plurality of quantized coefficients to a series of binary bins, and then apply an entropy coding algorithm to compress the binary bins to encoded bits. Examples of binarization methods include, but are not limited to, a truncated unary code, a combined truncated Rice (TR) and limited k-th order exponential-Golomb (EGk) binarization, and a k-th order exponential-Golomb binarization. Examples of entropy coding algorithms include, but are not limited to, variable length coding (VLC), context adaptive VLC (CAVLC), arithmetic coding, context adaptive binary arithmetic coding (CABAC), syntax-based context-adaptive binary arithmetic coding (SBAC), and probability interval partitioning entropy (PIPE). The entropy coding module 206 may also encode other parameters (such as partitioning mode flags, prediction mode flags, coded block flags, sub-block coded flags, and so on) necessary for decoding the picture from the video encoder 100 into the output bitstream. Then the video encoder 100 may output the output bitstream.

The inverse quantization module 207 may perform a scaling operation on the plurality of quantized coefficients to output a plurality of reconstructed coefficients. The inverse transform module 208 may perform one or more inverse transforms corresponding to the transform in the transform module 204 and output a reconstructed residual block. The reconstruction module 209 may calculate a reconstructed CB by adding the reconstructed residual block and the prediction block of the current CB generated by the prediction module 203. The reconstruction module 209 may send the reconstructed CB to the prediction module 203 to be used as an intra prediction reference. After all the CBs in a current picture or current sub-picture are reconstructed, the reconstruction module 209 may generate a reconstructed picture or reconstructed sub-picture by merging the reconstructed CBs. The filtering module 210 may perform loop filtering on the reconstructed picture or reconstructed sub-picture. The filtering module 210 may include one or more in-loop filtering operations, such as a deblocking filter, a sample adaptive offset (Sample Adaptive Offset, SAO) filter, an adaptive loop filter (Adaptive Loop Filter, ALF), a bilateral filter, a luma mapping with chroma scaling (LMCS) filter, and a neural network-based loop filter (NNLF). The output of the filtering module 210 is a decoded picture or decoded sub-picture, and these decoded pictures or decoded sub-pictures may be buffered in the decoded picture buffer module 211. The decoded picture buffer module 211 may output decoded pictures or decoded sub-pictures according to timing and control information. In addition, pictures stored in the decoded picture buffer module 211 may be used as a reference by the prediction module 203 to perform inter prediction or intra prediction.

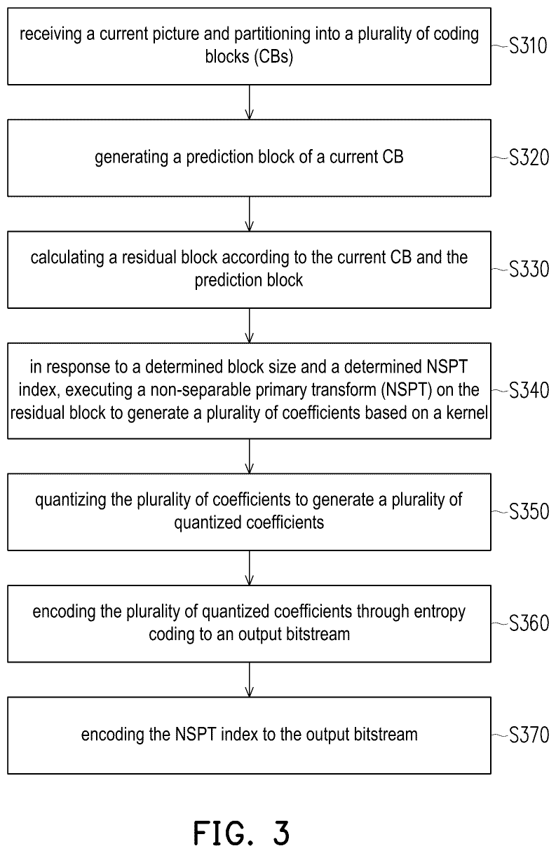

FIG. 3 is a flowchart of a video encoding method according to an embodiment of the invention. Referring to FIG. 1 to FIG. 3, the video encoder 100 may execute the following steps S310 to S370 to implement the video encoding method. In step S310, the partition module 201 may receive a current picture of an input video and partition the current picture into the plurality of CBs.

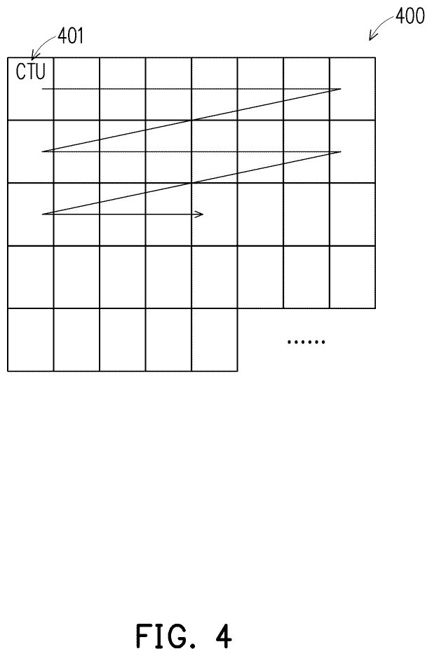

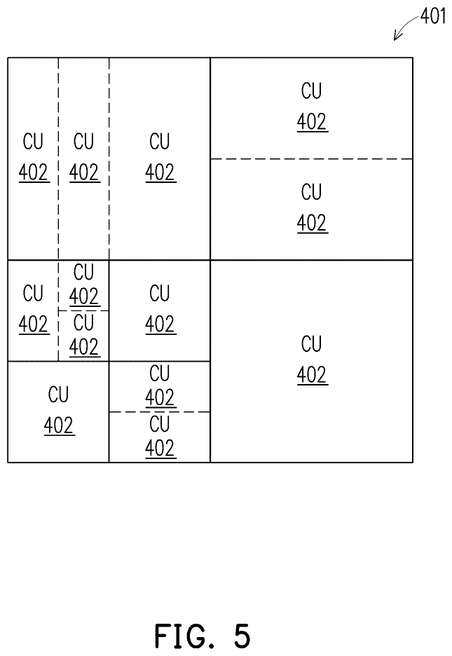

FIG. 4 is a schematic diagram of a picture divided into a plurality of blocks according to an embodiment of the invention. As shown in FIG. 4, a current picture 400 may be first divided into square blocks called CTUs 401. For example, the CTUs 401 may be blocks of 256×256 pixels. Then, referring to FIG. 5 additionally, FIG. 5 is a schematic diagram of a current CTU divided into a plurality of CUs according to an embodiment of the invention. In the embodiment of the invention, each CTU 401 in the picture may be further partitioned into one or more CUs 402. Each CU 402 may be rectangular or square, and each CU 402 may be as large as its root CTU 401 or be partitioned from the root CTU 401 into subdivisions as small as 4×4 blocks, as shown in FIG. 5. Each CU 402 consists of one or more spatially co-located coding blocks (CB), where each coding block corresponds to a colour component of the video.

In step S320, the prediction module 203 may generate a prediction block of a current CB. In the embodiment of the invention, the prediction module 203 generates the prediction block of the current CB by intra prediction. In step S330, the arithmetic module 202 may calculate a residual block according to the current CB and the prediction block. After prediction, the residual may still be highly spatially correlated. Although conditional entropy coding can capture some spatial dependency between adjacent samples, it is computationally impractical to form entropy coding statistical models that can fully exploit spatial correlation in the residual. In contrast, transform coding is a practical and effective method for spatially decorrelating the residual.

It should be noted that, in general the residual may be transformed by an integerised version of the DCT, which may be applied separately in the horizontal and vertical directions. For an M×N block of residual samples (where M is the width of the block and N is the height of the block), the transform coefficients may be obtained by applying an M×M DCT to each row, resulting in intermediate transform coefficients, and then applying an N×N DCT to each column of intermediate transform coefficients. The benefit of applying a transform can be estimated by the transform coding gain (Grc), which is defined as the ratio of distortion if the residual samples are scalar quantized directly at a fixed bit rate (Dso), compared to the distortion if the transform coefficients x are scalar quantized at the same bit rate (Drc). Under assumptions that the residual is statistically a wide-sense stationary Gaussian white source, and the transform is orthonormal, the transform coding gain can be further interpreted as the ratio of the arithmetic mean of the transform coefficient variance

$${σ}_{x}^{2}$$

compared to the geometric mean of

$${σ}_{x}^{2} .$$

$${G}_{T C} = \frac{{D}_{SQ}}{{D}_{T C}} \approx \frac{\frac{1}{N} {\sum }_{i} {σ}_{{x}_{i}}^{2}}{{( {\prod }_{i} {σ}_{{x}_{i}}^{2} )}^{\frac{1}{N}}} \qquad ( 1 )$$

By this second interpretation, transform coding gain, and correspondingly overall coding gain of the video coding system can be achieved when the resulting transform coefficients show energy compaction properties. That is, the variance distribution is concentrated in a few transform coefficients compared to the original residual samples, which are likely to be evenly distributed.

The use of one-dimensional transforms applied separately in the horizontal and vertical directions scales well computationally with increasing block size. In the above example the transform coefficients are obtained by a matrix implementation of the DCT, which results in (M+N) multiplications per sample. Even lower multiplications per sample can be achieved with “butterfly” factorisations, at the cost of slightly higher latency in the calculation. Separable transforms can optimally achieve energy compaction for spatial features along the Cartesian directions (i.e., vertical or horizontal). For example, a vertical edge is perfectly compacted by the vertical DCT. However, separable transforms cannot optimally exploit spatial features directed along non-Cartesian directions. In such cases, a well designed non-separable transform may achieve more coding performance.

While a separable transform applies one-dimensional transforms in the horizontal and vertical directions separately, a two-dimensional non-separable transform is applied directly to a block of input samples. One desirable property of transforms is for the transform vectors to span the space of the input samples. This means any input vector (i.e., any combination of values of the input samples) can be represented by a weighted sum of the transform vectors. For a transform to be spanning, one necessary condition is that there must at least be as many transform vectors as the dimensionality of the input space, or in other words, the number of transform coefficients output is at least equal to the number of input samples. For example, the one-dimensional DCTs in VVC are spanning transforms. Then for a spanning non-separable transform, if the block of input samples is an MxN residual, the transform will also output an M×N block of transform coefficients, which may be implemented by a matrix implementation of (M×N)×(M×N) multiplications.

To derive a non-separable transform which produces coding gain for a particular directional feature, the transform may be learned. For example, a representative set of residual blocks corresponding to the directional feature of interest may be grouped, and then the KLT may be calculated from the covariance matrix of the set of residual blocks. The process may be repeated over K different sets of residual blocks. Then in this example an overall transform kernel is derived with dimensionality (M×N)×(M×N)×K.

There are two problems with spanning non-separable transforms as described in this section. Firstly, the computation complexity is high. Because non-separable transforms are typically learned, they cannot generally be factorised. The matrix implementation of the spanning non-separable transform in the example above results in complexity of (M×N) multiplications per sample. The second problem is that the transform kernel(s) occupy a large amount of storage in the encoder and decoder. In the above example, a single kernel adaptable to K different directional features has (M×N)×(M×N)×K weights. This kernel can only be applied to residual blocks with size M×N. To allow the application of non-separable transform to multiple block sizes, a transform kernel must be learned for each discrete block size.

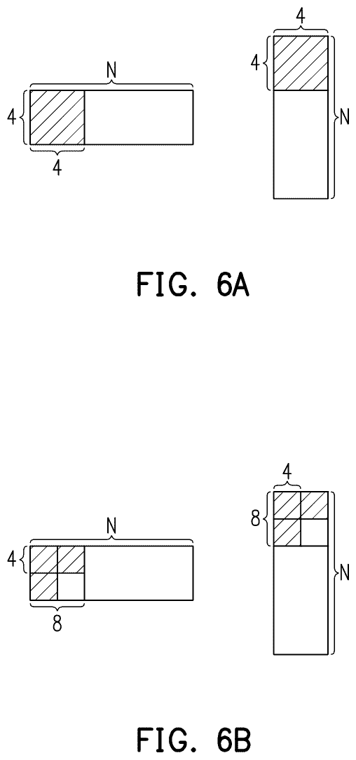

Hence, in VVC, a low frequency non-separable secondary transform (LFNST) tool was introduced with a number of modifications intended to address the problems described above for spanning non-separable transforms. Firstly, while the LFNST tool applies to a wide range of block sizes, only two LFNST kernels are defined. For blocks with size 4×N or N×4 (for N≥4), a smaller LFNST kernel is applied. For all larger block sizes (i.e., 8×8 or larger) a larger LFNST kernel is applied. Referring to FIG. 6A and FIG. 6B additionally shows the sample positions on which the LFNST acts. For example, from encoder perspective and for 4×N or N×4 block sizes, the top left 4×4 sample positions (indicated by the shaded regions in FIG. 6A) are transformed by the small LFNST. The remaining sample positions (indicated by the white regions in FIG. 6A) are ignored, or “zeroed out”. From the decoder perspective the inverse LFNST is applied to produce the top left 4×4 samples, while the remaining samples are filled in as zeros. A similar policy is applied for larger block sizes, where the LFNST acts on the 3 top left 4×4 blocks of sample positions (indicated by the shaded regions in FIG. 6B). The remaining sample positions are zeroed out.

As a consequence of the “zero out” policy, the LFNST is substantially reduced in size compared to a full size transform applying to all sample positions. However, it is inherently lossy and cannot restore the values at sample positions which are ignored by the LFNST. Such loss would be too large for the LFNST tool to be useful if it were applied directly to the residual samples. However, the LFNST is called a secondary transform because it is applied after the separable DCT at the encoder has already been performed, acting on primary transform coefficients to produce secondary transform coefficients. In other words, the DCT may be considered to be a primary transform. In this disclosure the left-most sample positions in a block of primary transform coefficients correspond to the horizontal low frequencies of the DCT, while the top-most sample positions correspond to the vertical low frequencies of the DCT. By preferentially transforming, and reconstructing at the decoder, the top-left sample positions, the LENST is able to reconstruct the low frequency information from the original residual. As described previously, transforms produce coding gain due to their energy compaction properties, and it has been well proven empirically that the variance (energy) of camera captured image and video signals is predominantly concentrated in the low frequency DCT coefficients. Therefore, while “zero out” prevents the LFNST from reconstructing an arbitrary residual block losslessly, in practice the loss can be minimal for most classes of image and video signals.

A second modification is that for both the small and large LFNST kernels, the transform applied is not a spanning transform. From the encoder perspective, the number of output (secondary transform) coefficients is less than the number of input (primary transform) coefficients. For example, the smaller LFNST kernel takes as input 4×4=16 primary transform coefficients, but produces only 8 output secondary transform coefficients. The larger LFNST kernel takes 3×4×4=48 input primary transform coefficients and outputs 8 secondary transform coefficients. The use of a non-spanning transform introduces further reconstruction loss. However, this loss can be traded off in a controlled manner against the complexity reduction achieved. A spanning non-separable transform may first be designed by the KLT method described above. By following this method, the basis vectors of the transform correspond to eigenvectors of the covariance matrix calculated from a representative set of residual blocks. These eigenvectors may be ranked in importance by their corresponding eigenvalues, with the most important eigenvectors selected to construct a non-spanning non-separable transform. For example, the 8 eigenvectors with the largest eigenvalues may be selected to form a non-spanning transform for the smaller LFNST kernel.

In summary the two modifications described above significantly reduce the complexity of the LFNST kernel compared to the spanning non-separable transform. For smaller blocks, the use of the smaller LFNST kernel reduces the potential complexity from (4×N)×(4×N) multiplications per transform block (for N≥4), down to 16×8 multiplications. For larger blocks, the use of the larger LFNST kernel reduces the potential complexity from (8×N)×(8×N) multiplications per transform block (for N≥8), down to 48×8 multiplications.

The LFNST kernels do not consist of only one transform matrix. To achieve better coding gain over a variety of image and video signals, multiple transform matrices are learned. The number of different transform matrices is the product of the 3^{rd} and 4^{th} dimensions of the LFNST kernel. The smaller LFNST kernel has dimensionality 16×8×2×4, and the larger LFNST kernel has dimensionality 48×8×2×4. The LFNST kernel is expressed with two additional dimensions because the particular transform matrix for a transform block is selected by a mixture of explicit signalling and implicit selection.

Explicit signalling is performed by an LFNST index signalled in the bitstream that may take the value 0, 1, or 2, where 0 indicates that the LFNST is not used for the transform block, while values 1 or 2 indicate selection in the 3^{rd} dimension of the LFNST kernel. The drawbacks of potential reconstruction loss due to the zero out and non-spanning simplifications are ameliorated by the explicit signalling mechanism. Where the use of LFNST would result in excessive reconstruction loss for a transform block, the LFNST tool can be disabled by signalling an LFNST index of 0.

Implicit selection is enabled by restricting the LFNST only to coding blocks which use intra prediction. Intra prediction produces a prediction block for the coding block from adjacent neighbouring reference samples to the top and left of the current block. The particular method of constructing the prediction block is signalled in the bitstream by an intra prediction mode. Simple methods of intra prediction include taking the average of the reference samples (“DC” mode), or constructing an affine interpolation between some reference samples (“planar” mode). However, the majority of the intra prediction modes are reserved for signalling intra angular directions, where the prediction block is constructed by assuming the reference sample values are replicated along a particular direction. When an intra angular direction is used, it may be a strong hint for the directional characteristics of the residual block. Implicit selection of an LFNST transform is performed by mapping the intra prediction mode to one of 4 possible values of a “transform set index”, which is used to index into the 4^{th} dimension of the LFNST kernel. The mapping used in VVC is shown in the following Table 1 (i.e. mapping from intra prediction mode to LFNST transform set index).

TABLE 1

| predModeIntra | lfnstTrSetIdx |
|---|---|
| predModeIntra < 0 | 1 |
| 0 <= predModeIntra <= 1 | 0 |
| 2 <= predModeIntra <= 12 | 1 |
| 13 <= predModeIntra <= 23 | 2 |
| 24 <= predModeIntra <= 44 | 3 |
| 45 <= predModeIntra <= 55 | 2 |
| 56 <= predModeIntra <= 80 | 1 |

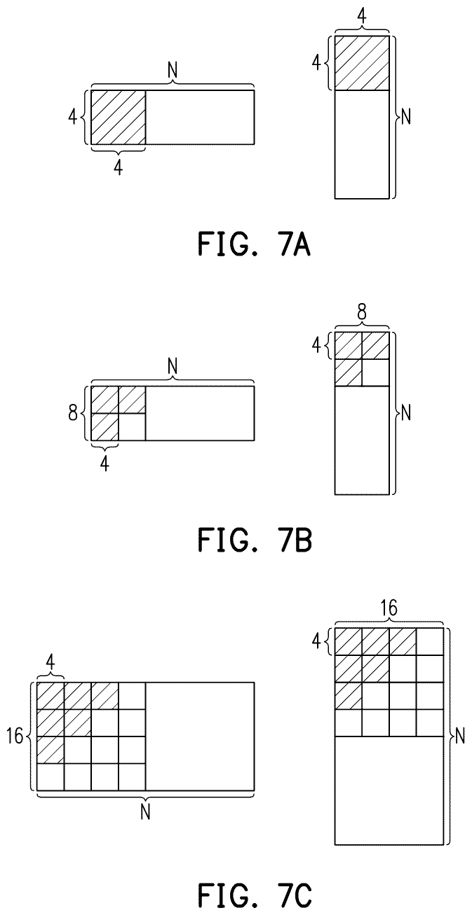

Moreover, in post-VVC exploratory activity, an extension to the LFNST has been proposed and integrated into an enhanced compression test model (ECM). The LFNST tool in ECM relaxes some of the complexity reductions imposed on the original LFNST tool adopted in VVC to achieve enhanced coding gain. ECM has three LFNST kernels. Similar to the LFNST tool in VVC, in most cases a significant portion of the transform block is zeroed out. Referring to FIG. 7A to 7C additionally, the shaded regions indicate the primary transform coefficient positions on which the LFNST in ECM acts, while the white regions indicate which transform coefficient positions are zeroed out. For blocks with size 4×N or N×4 (where N≥4), a small LFNST kernel is used on the top left 4×4 primary transform coefficients. For blocks with size 8×N or N×8 (where N≥8), a medium LFNST kernel is used on the 4 top left 4×4 blocks of primary transform coefficients. For 16×16 or larger blocks, a large LFNST kernel is used on the 6 top left 4×4 blocks of primary transform coefficients.

The size of the LFNST kernels in ECM may be 16×16×3×35 for the small LFNST kernel, 64×32×3×35 for the medium LFNST kernel, and 96×32×3×35 for the large LFNST kernel. Compared to the LFNST tool in VVC, the range of signalled LFNST indices is increased from 2 to 3, and the number of LFNST transform sets is increased from 4 to 35. The mapping from intra prediction mode to LFNST transform set index is shown in the following Table 2 (i.e. mapping from intra prediction mode to LFNST transform set index in ECM).

TABLE 2

| predModeIntra | lfnstTrSetIdx |
|---|---|
| predModeIntra < 0 | 2 |
| 0 <= predModeIntra <= 34 | predModeIntra |
| 35 <= predModeIntra <= 66 | 68 - predModeIntra |
| 67 <= predModeIntra <= 80 | 2 |

The complexity burden of the LFNST tool may be evaluated in three ways. Firstly, the additional storage burden imposed on decoders that must store the LFNST kernels. Secondly, the worst-case multiplications per sample that a decoder must perform if the LFNST tool is exercised. Thirdly, the additional multiplications per sample that an encoder would require if a full search over the LFNST tool was performed. By all three measures, the extended LFNST proposed in ECM is more complex that the LFNST of VVC. However, the worst-case decoder complexity, in terms of the total number of multiplications per sample, may still be less than the worst-case decoder complexity of other transform options.

For a matrix multiplication implementation of the DCT applied separately to an M×N size transform, the multiplications per sample are (M+N). Therefore, the worst-case complexity occurs for the largest value of (M+N). In practice, the complexity may be reduced by alternative implementations of the DCT such as butterfly factorisation, but it is still convenient to assess the complexity of a matrix multiplication implementation. The separable DCT has been extended in ECM so that the largest transform is the 128-point DCT. Then the worst-case complexity for the separable DCT is 128+128=256 multiplications per sample.

The worst-case decoder complexity of the LFNST in ECM may be assessed by considering a number of different block sizes. For a fair comparison, the assessment includes the cost of performing the primary transform. For a 4×4 block, the primary transform consists of 4+4=8 multiplications per sample. The LFNST consists of a 16×16 matrix multiplication, which is 16 multiplications per sample. Therefore, the overall cost of the LFNST for 4×4 blocks is 24 multiplications per sample.

For a 4×8 block, a naïve implementation of the primary transform would usually require eight 4×4 transforms along the short dimension and four 8×8 transforms along the long dimension, resulting in an overall 4+8=12 multiplications per sample. However, because the LFNST only reconstructs non-zero coefficient values in the top-left 4×4 block of primary transform coefficient positions, an optimised decoder would be able to take advantage by only performing four 4×4 transforms along the short dimension, then four 4×8 transforms along the long dimension, resulting in an overall 2+4=6 multiplications per sample. As the order of the separable transforms is generally fixed, in the worst case the decoder may be required to perform four 4×8 transforms along the long dimension first, then eight 4×4 transforms along the short dimension, resulting in 4+4=8 multiplications per sample. The LFNST is still a 16×16 matrix multiplication whose cost is amortised over a larger block, resulting in 8 multiplications per sample. Then the worst-case cost of the LFNST for 4×8 blocks is 16 multiplications per sample. The same principles apply generally for 4×N or N×4 block sizes. Therefore, the multiplications per sample for 4×N or N×4 blocks will always be less than or equal to the multiplications per sample for 4×4 blocks.

For an 8×8 block, the primary transform consists of 8+8=16 multiplications per sample. The LFNST consists of a 64×32 matrix multiplication, which is 32 multiplications per sample. Then the overall cost of the LFNST for 8×8 blocks is 48 multiplications per sample.

For an 8×16 block, we again assume that an optimised decoder would take advantage of the zero-out properties of LFNST reconstruction. Only the top left 8×8 block of primary transform coefficient positions is non-zero. Then, an optimised decoder may take advantage of this by only performing eight 8×8 transforms along the short dimension, then eight 8×16 transforms along the long dimension, resulting in an overall 4+8=12 multiplications per sample. Alternatively, the optimised decoder may perform eight 8×16 transforms along the long dimension first, then sixteen 8×8 transforms along the short dimension, resulting in 8+8=16 multiplications per sample. The LFNST adds another (64×32)/(8×16)=16 multiplications per sample, resulting in an overall worst-case complexity of 32 multiplications per sample. As before, the multiplications per sample for 8×N or N×8 blocks are always less than or equal to the multiplications per sample for 8×8 blocks.

For a 16×16 block, the zero-out properties of LFNST reconstruction mean that only six 4×4 blocks of primary transform coefficients in the pattern as shown in FIG. 7C have non-zero values. For simplicity let us assume a more relaxed pattern where the top-left 12×12 block of primary transform positions may have non-zero values. Then, an optimised decoder may take advantage of this by only performing firstly twelve 12×16 transforms in one dimension, then sixteen 12×16 transforms in the second dimension consists of 9+12=21 multiplications per sample. The LFNST consists of (96×32)/(16×16)=12 multiplications per sample, resulting in an overall complexity of 33 multiplications per sample.

For an M×N block where M, N≥16, an optimised decoder may perform firstly twelve 12×M transforms in one dimension, then M 12×N transforms in the second dimension, resulting in (12×12)/N+12 multiplications per sample to perform the separable DCT. Then the worst-case complexity occurs for the smallest value of N=16, which is 21 multiplications per sample and equal to the complexity for 16×16 blocks. The LFNST adds another (96×32)/(M×N) multiplications per sample, which is always less than or equal to the multiplications per sample for 16×16 blocks. Therefore, the overall complexity of the LFNST in ECM for larger M×N block sizes is always equal to or less than the multiplications per sample for 16×16 blocks.

After assessing the decoder complexity of the LFNST in ECM exhaustively across different block sizes, it is shown that the worst-case complexity is 48 multiplications per sample (occurring in the case of 8×8 blocks). Somewhat surprisingly, this worst-case complexity includes the cost of performing the separable DCT, but due to optimisations possible from LFNST zero-out it is significantly less than the worst-case complexity of performing the separable DCT alone (which is assessed as 256 multiplications per sample).

As seen above, the use of non-separable secondary transform allows significant complexity reductions due to the use of zero-out on selected primary transform coefficient regions.

However, further coding may be possible with the NSPT. An initial study on non-separable primary transforms found that significant gains (3.43% average rate reduction by the Bjontegaard metric) could be achieved, although the transforms implemented were complex and the kernel weights were obtained by overfitting to the test data set.

A practical implementation of NSPT was proposed. In this proposal, the NSPT is only applied to a small set of block sizes as 4×4, 4×8, 8×4, and 8×8. For these block sizes, the NSPT replaces the LFNST. As with the LFNST, the NSPT kernels are trained, with a selection of an appropriate matrix for a particular block guided by both a signalled index and implicit selection through the intra prediction mode. Three NSPT kernels are proposed. For 4×4 blocks, a small NSPT kernel with dimensions 16×16×3×35 is used. For 4×8 and 8×4 blocks, a medium NSPT kernel with dimensions 32×20×3×35 is used. For 8×8 blocks, a large NSPT kernel with dimensions 64×32×3×35 is used.

In general, the zero-out transform may not be used in the proposed NSPT, so the first dimension of each kernel is always equal to the number of samples in the block. For the medium and large NSPT kernels the second dimension is smaller than the first dimension, meaning that the NSPT in these cases is a lossy transform. As with the LFNST, an NSPT index is signalled in the bitstream that may take the value 0, 1, 2, or 3, where 0 indicates that the NSPT is not used for the transform block, while values 1-3 indicate selection within the corresponding NSPT kernel along the 3^{rd} dimension. Selection along the 4^{th} dimension of the NSPT kernel is determined by mapping from the intra prediction mode, in the same manner as for the extended LFNST in ECM.

The kernel sizes and the block sizes for which NSPT is enabled are carefully designed so that the NSPT may be practically implemented. This may be confirmed by comparing the complexity of the NSPT at each block size against the complexity of the corresponding LFNST it replaces. For 4×4 blocks, the NSPT has a complexity of 16 multiplications per sample compared with the LFNST complexity of 24 multiplications per sample. For 4×8 and 8×4 blocks, the NSPT has a complexity of 20 multiplications per sample compared with the LFNST complexity of 16 multiplications per sample. For 8×8 blocks, the NSPT has a complexity of 32 multiplications per sample compared with the LFNST complexity of 48 multiplications per sample. Therefore, there is no increase in worst-case decoder complexity.

In the proposed implementation of the NSPT described above, the NSPT kernel is designed to replace the LFNST for specific block sizes so that the worst-case multiplications per sample decoder complexity is not increased. The following embodiments provide a number of solutions for improving the gain of the NSPT while keeping the worst-case decoder complexity practical.

Hence, returning to FIG. 1 to FIG. 3, in step S340, in response to a determined block size and a determined NSPT index, the transform module 204 may execute the NSPT on the residual block to generate a plurality of coefficients based on a kernel. In one embodiment of the invention, in response to the residual block having a block size of 8×16, a NSPT transform matrix is selected from a kernel with dimensionality A×B×C×D, wherein the parameter A has the value 128, the parameter C has the value 3, and the parameter D has the value 35. It should be noted that in this disclosure, the dimensionality “A” represents a number of input samples from the residual block, the dimensionality “B” represents a number of transform coefficients produced by the NSPT, the dimensionality “C” represents a number of indexed sets, and the dimensionality “D” represents a number of transform sets. The order of the dimensions of the kernel described in this disclosure are only provided as an example for the purposes of describing how a NSPT transform matrix is selected, and may be different in implementations of NSPT.

The NSPT transform matrix is selected by indexing the “C” and “D” dimensions of the kernel, resulting in a NSPT transform matrix with size A×B. The NPST index may take the value 1, 2, or 3, and the value of the NSPT index is used to index the “C” dimension of the kernel. The value of the NSPT index may be determined by the video encoder 100 performing a rate-distortion optimisation (RDO) over all possible values of the NSPT index and choosing the value that minimises a RD cost. As described above with reference to step S320, the prediction block is generated by intra prediction, which is associated with an intra prediction mode. The intra prediction mode is mapped to a transform set index by the mapping process described above with reference to Table 2. The transform set index is used to index the “D” dimension of the kernel.

In one example of the present embodiment of the invention, the NSPT is executed on the residual block by a matrix multiplication. The samples of the residual block may be arranged by a raster scan order into a one-dimensional column vector R of 128×1 samples. Let the selected NSPT transform matrix be T with size A×B, which in the present embodiment is 128×B. Then the NSPT may be executed by performing a matrix multiplication using the transpose of the NSPT transform matrix on the samples of the residual block, P=T^{T}R, such that the result P of the matrix multiplication is a one-dimensional column vector of B×1 transform coefficients. Note that in the matrix multiplication, each column of T^{T} corresponds to a sample position in the column vector R, which by the raster scan order described above corresponds to a spatial position in the residual block. The raster scan order described above for constructing v is just one example, and in different implementations a different scan order can be used if the NSPT kernel is modified such that the columns of T^{T} correspond to the same spatial positions in the residual block. The column vector P may then be inserted in a hierarchical diagonal scan order into a two-dimensional block of transform coefficients with the same size as the residual block. Either the one-dimensional vector P or the two-dimensional block of transform coefficients may be referred to as the plurality of coefficients.

In another embodiment of the invention, in response to the residual block having a block size of 16×8, the NSPT transform matrix T is selected from a kernel with dimensionality A×B×C×D, wherein the parameter A has the value 128, the parameter C has the value 3, and the parameter D has the value 35. The value of the NSPT index is used to index the “C” dimension of the kernel, and the transform set index is used to index the “D” dimension of the kernel. In one example of the present embodiment of the invention, the NSPT is executed on the residual block by the matrix multiplication P=T^{T}R, wherein the samples of the residual block are arranged by a raster scan order into the one-dimensional column vector R of 128×1 samples. The column vector P may then be inserted in a hierarchical diagonal scan order into a two-dimensional block of transform coefficients with the same size as the residual block. Either the one-dimensional vector P or the two-dimensional block of transform coefficients may be referred to as the plurality of coefficients.

Specifically, the NSPT may be extended to and replaces the LFNST for 8×16 and 16×8 block sizes. For these block sizes additional NSPT kernels are trained with dimensionality 128×B×C×D, where the parameter B is the number of transform coefficients produced by the NSPT from the encoder perspective. The parameter C may be set to 3 and the parameter D may be set to 35 to match the current dimensionality of the kernels used in both the extended LFNST kernels in ECM and the proposed NSPT, however these dimensions may change if the overall design of the LFNST and NSPT is further modified. The number of transform coefficients is set so that the worst-case decoder complexity with the extended NSPT, and the overall complexity of the encoder with the extended NSPT are no worse than the corresponding complexity of the LFNST tool that it replaces. The worst-case LFNST complexity for 8×16 and 16×8 blocks is 32 multiplications per sample. In one embodiment of the invention, the parameter B=32. However, in another embodiment of the invention, the parameter B may be set to a value close to but not equal to 32, with the exact value selected according to empirical confirmation that a reference encoder complexity is not increased for this value of the parameter B.

In another embodiment of the invention, in response to the residual block having a block size of 16×16, the NSPT transform matrix T is selected from a kernel with dimensionality A×B2×C×D, wherein the parameter A has the value 256, the parameter C has the value 3, and the parameter D has the value 35. The value of the NSPT index is used to index the “C” dimension of the kernel, and the transform set index is used to index the “D” dimension of the kernel. In one example of the present embodiment of the invention, the NSPT is executed on the residual block by the matrix multiplication P=T^{T}R, wherein the samples of the residual block are arranged by a raster scan order into the one-dimensional column vector R of 256×1 samples. The column vector P may then be inserted in a hierarchical diagonal scan order into a two-dimensional block of transform coefficients with the same size as the residual block. Either the one-dimensional vector P or the two-dimensional block of transform coefficients may be referred to as the plurality of coefficients.

Specifically, the NSPT may be extended to and replaces the LFNST for 8×16, 16×8, and 16×16 block sizes. For 8×16 and 16×8 block sizes additional NSPT kernels are trained with dimensionality 128×B1×C×D, while for 16×16 block sizes another additional NSPT kernel is trained with dimensionality 256×B2×C×D. The parameter C may be set to 3 and the parameter D set to 35 to match the current dimensionality of the kernels used in both the extended LFNST kernels in ECM and the proposed NSPT, however these dimensions may change if the overall design of the LFNST and NSPT is further modified. The number of transform coefficients (B1 and B2) for each of the additional NSPT kernels are set so that the worst-case decoder complexity with the extended NSPT, and the overall complexity of the encoder with the extended NSPT are no worse than the corresponding complexity of the LFNST tool that it replaces. The worst-case LFNST complexity for 8×16 and 16×8 blocks is 32 multiplications per sample, while the worst-case LFNST complexity for 16×16 blocks is approximately 33 multiplications per sample (depending on the degree to which the primary transform is optimised for zeroed-out transform coefficient positions). Then, in one embodiment of the invention, the parameter B1 is 32, and the parameter B2 is 32. In another embodiment of the invention, the parameters B1 and B2 may be set to values close to but not equal to 32, with the exact values selected according to empirical confirmation that a reference encoder complexity is not increased for these values.

In step S350, the quantization module 207 may quantize the plurality of coefficients to generate the plurality of quantized coefficients. In step S360, the entropy coding module 208 may encode the plurality of quantized coefficients to the output bitstream. In step S370, the entropy coding module 208 may encode the NSPT index to the output bitstream. Therefore, the video encoder 100 and the video encoding method thereof may implement low complexity NSPT for compressing residual data by the above designed kernel matrix.

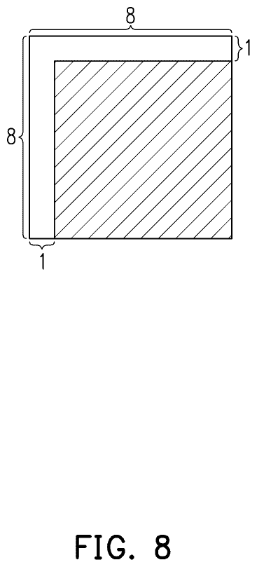

FIG. 8 is a schematic diagram of a zero-out region according to an embodiment of the invention. Referring to FIG. 1 to FIG. 3 and FIG. 8, the prediction module 203 may further execute a zero-out on the residual block, so that the residual block after zero-out has a zero-out region. From the encoder perspective zero-out may be applied to the input side (residual sample positions) of the NSPT kernel to further reduce their complexity. With the LFNST tool, the preserved DCT transform coefficient positions occupy the top-left (low frequency) portion of the transform block and the zero-out regions are in the bottom-right (high frequency) portion of the transform block. In contrast, the preserved residual sample positions for the NSPT are in the bottom-right portion of the residual block, and the zero-out region is sample positions at the top-left edge of the residual block. The reason for this is intra prediction is based on a set of reference samples occupying a top-left neighbourhood of the coding block, and the correlation between the reference samples and the coding block samples is highly dependent on spatial closeness. The residual samples (which are equivalent to the prediction error) are likely to be the smallest in magnitude at sample positions close to the reference neighbourhood. These positions are at the top-left edge of the residual block and are therefore least likely to cause significant reconstruction error if they are neglected completely by zero-out.

For example, as shown in FIG. 8, FIG. 8 shows an example arrangement for an 8×8 block. In this example the top-left edge of sample positions with thickness 1 is zeroed out. From the encoder perspective the bottom right 7×7 sample positions (indicated by the shaded regions in FIG. 8) are transformed by an NSPT kernel which is 49×32×3×35 in size. The top left edge of sample positions (indicated by the white regions in FIG. 8) are ignored, or “zeroed out”. From the decoder perspective the inverse NSPT is applied to produce the bottom right 7×7 residual samples, while the remaining residual samples are filled in as zeros. Compared to the NSPT kernel for 8×8 blocks which has a complexity of 32 multiplications per sample, this kernel has a complexity of 24.5 multiplications per sample, which is a 24% reduction. Similar zero-out regions along the top-left edge of the NSPT kernels for 4×4, 4×8 and 8×4 block sizes may be defined, with consequent reductions in the NSPT kernels to 9×9×3×35 for 4×4 blocks (5 multiplications per sample, 69% reduction in complexity) and 21×20×3×35 for 4×8 or 8×4 blocks (13.1 multiplications per sample, 35% reduction).

In another embodiment of the invention, a reduced zero-out region compared to the example of FIG. 8 may be applied to some NSPT kernels. For example, the zero-out region may be reduced to only the single top-left sample position of the residual block. The size of the zero-out region may be designed for each NSPT kernel to trade-off complexity against reconstruction error.

In another embodiment of the invention, an increased zero-out region with thickness N compared to the example of FIG. 8 may be applied to some NSPT kernels. For example, the zero-out region may be increased in thickness to the top-left edge of sample positions 2 samples wide.

In another embodiment of the invention, a reduced zero-out region compared to FIG. 8 may be selected dependent on the intra prediction mode. For example, when the intra prediction mode is predominantly in a horizontal direction indicating that the CU is mostly predicted by the left reference samples, the reduced zero-out region may be the left edge of the residual block.

Referring to FIG. 1 to FIG. 3, in response to a size of the residual block being larger than a block size supported by a largest NSPT kernel, the transform module 204 may further partition the residual block into a plurality of smaller transform blocks. Specifically, let the largest NSPT kernel size be defined as applying to blocks of size M×N. For example, M may be 16, and N may be 16. However, the NSPT tool is enabled, and replaces the LFNST, for block sizes up to and including P×Q, where P>M and Q>N. Let the coding block size be RxS. In the present embodiment the coding block is larger than the block size supported by the largest NSPT kernel, that is R≥M and S≥N. The intra prediction mode is signalled for the coding block, and from the encoder perspective a predictor is determined according to that intra prediction mode, subtracting from the coding block samples to produce the residual. In this regard, the non-zero NSPT index is signalled, indicating that an NSPT will be applied to the residual while a zero NSPT index indicates that no NSPT will be applied to the residual. In the present embodiment of the invention, instead of applying a transform directly to the residual block, it is implicitly split, or partitioned into smaller transform blocks before applying the NSPT. Therefore, the NSPT of the above embodiment may be extended to a much larger range of block sizes.

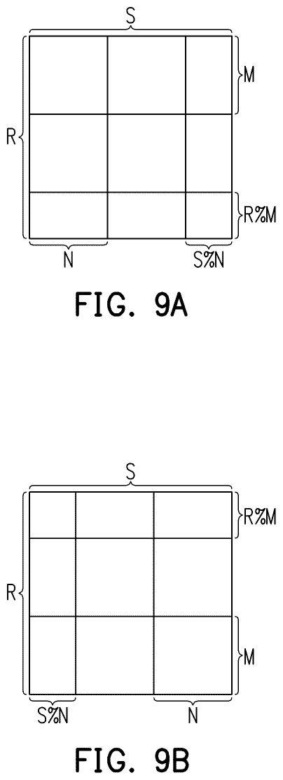

FIG. 9A is a schematic diagram of splitting the residual block according to an embodiment of the invention. FIG. 9B is a schematic diagram of splitting the residual block according to another embodiment of the invention. Referring to FIG. 1 to FIG. 3, FIG. 9A and FIG. 9B, in one embodiment of the invention, the RxS residual block of the above embodiemtn may be implicitly split where possible into transform blocks of size M×N. When R and S are not integer multiples of M and N respectively, then smaller blocks with dimensions (R % M) and (S % N) will occur, where % represents the modulus or “remainder” operator. In one embodiment of the invention, the implicit split is aligned with the top-left corner of the residual block, so that smaller blocks when existing will occur at the bottom and right sides of the residual block. In another one embodiment of the invention, the implicit split is aligned with the bottom-right corner of the residual block, so that smaller blocks when existing will occur at the top and left sides of the residual block. Both arrangements of the implicit split are shown in FIG. 9A and FIG. 9B. Moreover, each transform block is processed by an NSPT kernel for the corresponding block size, with a selection of a specific transform matrix determined by the signalled NSPT index, and by mapping the intra prediction mode to a transform set index.

The advantage may be understood by considering an implicit split into integer multiples of M×N transform blocks. The multiplications per sample in such a case are equal to the number of output transform coefficients B produced by the selected NSPT. However, the total number of transform coefficients produced for the coding block is B per transform block. If an NSPT were applied directly to the coding block without implicit split, to achieve the same multiplications per sample the NSPT kernel would need to consist of B output transform coefficients as well. However, in this case the total number of transform coefficients is B for the entire coding block. This amount of transform coefficients may be insufficient to reconstruct the coding block without suffering a very large reconstruction error, making a direct application of NSPT to a large block useless for video coding.

In addition, in the case of the embodiment of FIG. 8, zero-out may be applied in a limited manner only to transform blocks located on the top or left edge of the residual block. This means that both zero-out or full size versions of the same NSPT kernel may be applied, depending on the location of a transform block within the residual.

In one embodiment of the invention, the NSPT index may be signalled for each transform block. This increases the signalling cost of the NSPT tool, but potentially improves the reconstruction error such that an overall improvement in rate-distortion trade-off may be possible.

In one embodiment of the invention, the NSPT index may be signalled for each unique transform block size. Transform blocks with the same block size share a common NSPT index. Therefore, the total number of NSPT indices signalled may be 1, 2, or 4, depending on whether the residual block is an integer multiple of the largest block size supported by NSPT kernels.

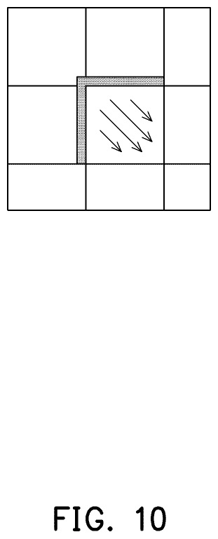

In one embodiment of the invention, the intra prediction mode is signalled for the coding block, and then a non-zero NSPT index is signalled, indicating that an NSPT will be applied. Unlike the above embodiments, when the coding block is larger than the block size supported by the largest NSPT kernel, from the encoder perspective the coding block is implicitly split into smaller prediction blocks before applying intra prediction. The implicit split follows the same policy as described above with reference to FIG. 9, except prediction blocks are produced rather than transform blocks. Each prediction block is predicted according to the signalled intra prediction mode, resulting in a residual block from each prediction block. However, each predictor is determined from reference samples directly neighbouring the top-left border of the corresponding prediction block. An example of this prediction process for one prediction block is shown in FIG. 10. FIG. 10 is a schematic diagram of local prediction according to another embodiment of the invention. From the decoder perspective, this means that a predictor cannot be determined until the prediction blocks to the top and left have been fully reconstructed. This may reduce the size of the residuals as prediction is performed more locally, at the cost of increased sequential dependency. However, the sequential dependency is no worse than the worst-case that the decoder may already encounter, which occurs when the CTU is partitioned into the smallest possible size for CUs.

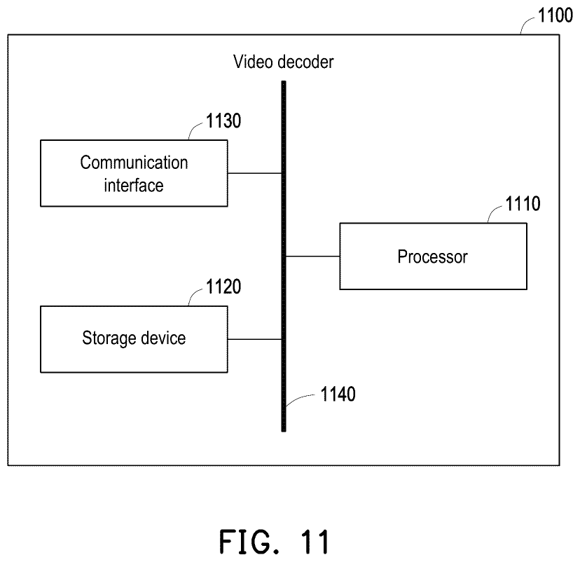

FIG. 11 is a schematic diagram of a video decoder according to an embodiment of the invention. Referring to FIG. 11, the video decoder 1100 includes a processor 1110, a storage device 1120, a communication interface 1130, and a data bus 1140. The processor 1110 is electrically connected to the storage device 1120, the communication interface 1130 through the data bus 1140. The storage device 1120 may store relevant instructions, and may further store relevant video decoders of algorithms. The processor 1110 may receive the bitstream from the communication interface 1130. The processor 1110 may execute the relevant video decoder and/or the relevant instructions to implement the video decoding method of the invention.

In one embodiment of the invention, the video decoder 1100 may be implemented by one or more PC, one or more server computer, and one or more workstation computer or composed of multiple computing devices, but the invention is not limited thereto. In another embodiment of the invention, the video decoder 1100 may include more processors for executing the relevant video encoders and/or the relevant instructions to implement the video decoding method of the invention. In addition, in one embodiment of the invention, the video decoder 1100 may include more processors for executing the relevant video decoders and/or the relevant instructions to implement the video decoding method of the invention. The video decoder 1100 may be used to implement a video codec and can perform a video decoding function in the invention.

In one embodiment of the invention, the processor 1110 may include, for example, a CPU, a GPU, or other programmable general-purpose or special-purpose microprocessor, DSP, ASIC, PLD, other similar processing circuits or a combination of these devices. In one embodiment of the invention, the storage device 1120 may be a non-transitory computer-readable recording medium, such as a ROM, an EPROM, an EEPROM or an NVM, but the present invention is not limited thereto.

In one embodiment of the invention, the relevant video decoders and/or the relevant instructions may also be stored in the non-transitory computer-readable recording medium of one apparatus and executed by the processor of another one apparatus. The communication interface 1130 is, for example, a network card that supports wired network connections such as Ethernet, a wireless network card that supports wireless communication standards such as Institute of IEEE 802.11n/b/g/ac/ax/be, or any other network connecting device, but the embodiment is not limited thereto. The communication interface 1130 is configured to retrieve an input bitstream.

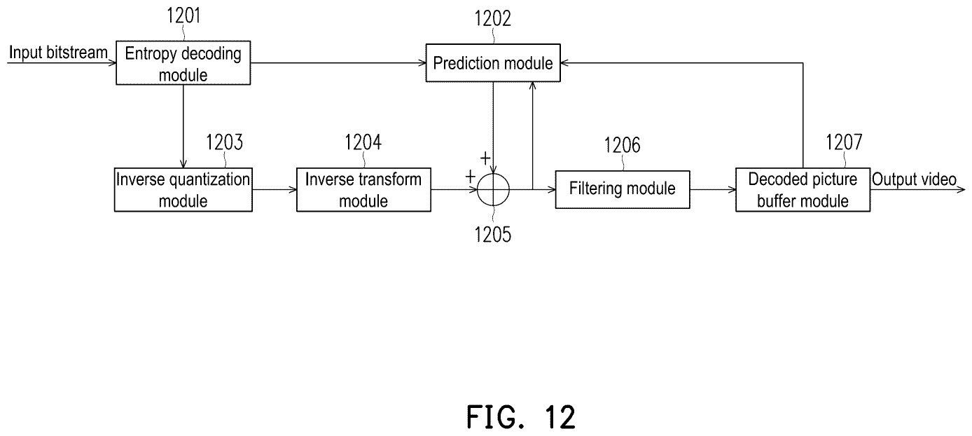

FIG. 12 is a schematic diagram of a video decoding process according to an embodiment of the invention. Referring to FIG. 11 and FIG. 12, the video decoder 1100 may decode the input bitstream to the output video by performing the video decoding process of FIG. 12. In the embodiment of the invention, the storage device 120 may store algorithms of an entropy decoding module 1201, a prediction module 1202, an inverse quantization module 1203, an inverse transform module 1204, a reconstruction module 1205 (e.g. adder module or subtraction module), a filtering module 1206 and a decoded picture buffer module 1207. The processor 1110 may execute the above modules to perform the video decoding process.

In one embodiment of the invention, the processor 1110 may receive an input bitstream from an external video source. The entropy decoding module 1201 may parse the input bitstream and obtains values of syntax elements from the input bitstream. The entropy decoding module 1201 may decode the input bitstream to obtain a plurality of quantized coefficients, and may decode entropy-encoded syntax elements from the input bitstream. The entropy decoding module 1201 may convert the binary representations of the entropy-encoded syntax elements into numerical values. The entropy decoding module 1201 may send the values of the syntax elements, as well as one or more variables set or determined according to the values of the syntax elements, for obtaining one or more decoded pictures to the modules in the video decoder 1200. The prediction module 1202 may determine a prediction block of a current coding block (CB). Note that although the process is decoding, such blocks are still referred to as coding blocks. The prediction module 1202 may include an intra prediction module. When it is indicated that the intra prediction mode is used for decoding the current CB, the prediction module 1202 may transmit the relevant parameters from the entropy decoding module 1201 to the intra prediction module to obtain an intra prediction block.

The inverse quantization module 1203 may inversely quantize the plurality of quantized coefficients to generate a plurality of reconstructed coefficients. The inverse transform module 1204 may execute an inverse NSPT on the plurality of reconstructed coefficients to generate a reconstructed residual block based on a (NSPT) kernel. The reconstruction module 1205 may generate a reconstructed CB according to the reconstructed residual block and the prediction block. Moreover, the reconstructed CB may also be sent to the prediction module 1202 to be used as a reference for other blocks encoded in the intra prediction mode.

After all the CBs in a current picture or current sub-picture have been reconstructed, the reconstructed CBs are merged to produce a reconstructed picture or reconstructed sub-picture. The filtering module 1206 may perform in-loop filtering on the reconstructed picture or reconstructed sub-picture. The filtering module 1206 may include one or more in-loop filtering operations, such as a deblocking filter, a sample adaptive offset (SAO) filter, an adaptive loop filter (ALF), a bilateral filter, a luma mapping with chroma scaling (LMCS) filter, and a neural network-based loop filter (NNLF). The filtering module 1206 may output a decoded picture or decoded sub-picture, and the decoded picture or decoded sub-picture is buffered in the decoded picture buffer module 1207. The decoded picture buffer module 1207 may output decoded pictures or decoded sub-pictures according to timing and control information. Pictures stored in the decoded picture buffer module 1207 may be used as a reference by the prediction module 1202 to perform inter prediction or intra prediction.

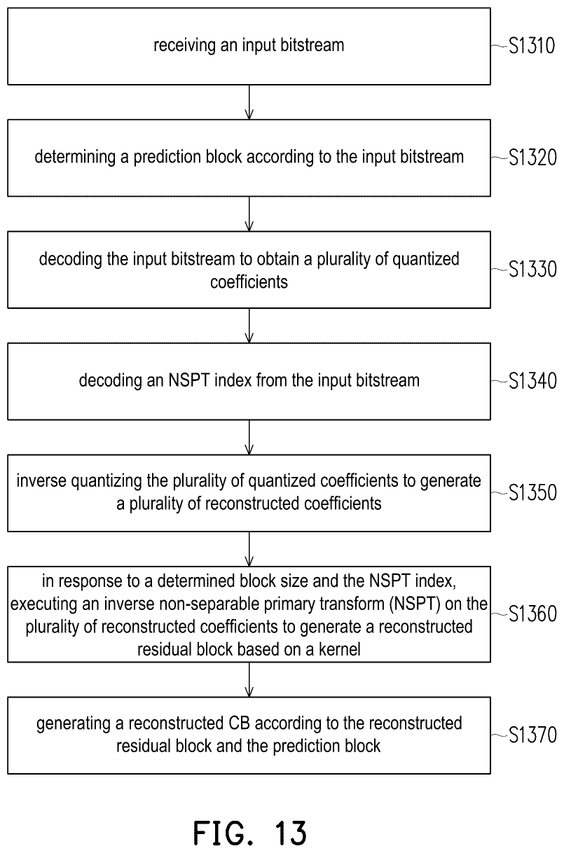

FIG. 13 is a flowchart of a video decoding method according to an embodiment of the invention. Referring to FIG. 11 to FIG. 13, the video decoder 1100 may execute the following steps S1310 to S1370 to implement the video decoding method. In step S1310, the video decoder 1100 may receive the input bitstream. In step 1320, the prediction module 1202 may determine a prediction block for a current coding block (CB) according to an intra prediction mode. The intra prediction mode may be determined by prediction mode flags decoded from the input bitstream. In step 1330, the entropy decoding module 1201 may decode the input bitstream to obtain the plurality of quantized coefficients. In step 1340, the entropy decoding module 1201 may decode the input bitstream to obtain an NSPT index with a value of 1, 2, or 3. In step S1350, the inverse quantization module 1203 may inversely quantize the plurality of quantized coefficients to generate the plurality of reconstructed coefficients. In step S1360, in response to a determined block size and the decoded NSPT index, the inverse transform module 1204 may execute an inverse non-separable primary transform (NSPT) on the plurality of reconstructed coefficients to generate a reconstructed residual block based on a kernel.

In one embodiment of the invention, in response to the current CB having a block size of 8×16, a NSPT transform matrix is selected from a kernel with dimensionality A×B×C×D, wherein the parameter A has the value 128, the parameter C has the value 3, and the parameter D has the value 35. The size of the current CB may be determined by partitioning mode flags previously decoded from the input bitstream. It should be noted that in this disclosure, the dimensionality “A” represents a number of input samples from the residual block, the dimensionality “B” represents a number of transform coefficients produced by the NSPT, the dimensionality “C” represents a number of indexed sets, and the dimensionality “D” represents a number of transform sets. The order of the dimensions of the kernel described in this disclosure are only provided as an example for the purposes of describing how a NSPT transform matrix is selected, and may be different in implementations of NSPT.

The NSPT transform matrix is selected by indexing the “C” and “D” dimensions of the kernel, resulting in a NSPT transform matrix with size A×B. The value of the NSPT index is used to index the “C” dimension of the kernel. As described above with reference to step S1320, the prediction block is generated by intra prediction, which is associated with an intra prediction mode. The intra prediction mode is mapped to a transform set index by the mapping process described above with reference to Table 2. The transform set index is used to index the “D” dimension of the kernel.

In one example of the present embodiment of the invention, the inverse NSPT is executed on the plurality of reconstructed coefficients by a matrix multiplication. The reconstructed coefficients are typically decoded in a hierarchical reverse diagonal scan order, which means coefficients corresponding to high spatial frequencies are decoded before coefficients corresponding to low spatial frequencies. Then the reconstructed coefficients may be arranged in reverse order (i.e., hierarchical forward diagonal scan order) into a one-dimensional column vector P of B×1 samples. Let the selected NSPT transform matrix be T with size A×B, which in the present embodiment is 128×B. Then the inverse NSPT may be executed by performing a matrix multiplication using the NSPT transform matrix on the reconstructed coefficients, R=TP, such that the result R of the matrix multiplication is a one-dimensional column vector of 128×1 reconstructed residual coefficients. The column vector R may then be arranged by a raster scan order into a two-dimensional reconstructed residual block with the same size as the current CB. Note that in the matrix multiplication, each row of T corresponds to a sample position in the column vector R, which by the raster scan order described above corresponds to a spatial position in the reconstructed residual block. The raster scan order described for constructing the reconstructed residual block is just one example, and in different implementations a different scan order can be used if the NSPT kernel is modified such that the columns of T correspond to the same spatial positions in the reconstructed residual block.

In another embodiment of the invention, in response to the current CB having a block size of 16×8, a NSPT transform matrix T is selected from a kernel with dimensionality A×B×C×D, wherein the parameter A has the value 128, the parameter C has the value 3, and the parameter D has the value 35. The value of the NSPT index is used to index the “C” dimension of the kernel, and the transform set index is used to index the “D” dimension of the kernel. In one example of the present embodiment of the invention, the inverse NSPT is executed on the plurality of reconstructed coefficients by the matrix multiplication R=TP, wherein the samples of R are arranged by a raster scan order to generate the two-dimensional reconstructed residual block.

Specifically, the NSPT may be extended to and replaces the LFNST for 8×16 and 16×8 block sizes. For these block sizes additional NSPT kernels are trained with dimensionality 128×B×C×D, where the parameter B is the number of transform coefficients produced by the NSPT from the encoder perspective. The additional NSPT kernels are the same as the additional NSPT kernels available to the video encoder 100. In one embodiment of the invention, the parameter B=32. However, in another embodiment of the invention, the parameter B may be set to a value close to but not equal to 32, with the exact value selected according to empirical confirmation that a reference encoder complexity is not increased for this value of the parameter B.

In another embodiment of the invention, in response to the current CB having a block size of 16×16, a NSPT transform matrix T is selected from a kernel with dimensionality A×B×C×D, wherein the parameter A has the value 256, the parameter C has the value 3, and the parameter D has the value 35. The value of the NSPT index is used to index the “C” dimension of the kernel, and the transform set index is used to index the “D” dimension of the kernel. In one example of the present embodiment of the invention, the inverse NSPT is executed on the plurality of reconstructed coefficients by the matrix multiplication R=TP, wherein the samples of R are arranged by a raster scan order to generate the two-dimensional reconstructed residual block.

Specifically, the NSPT may be extended to and replaces the LFNST for 8×16, 16×8, and 16×16 block sizes. For 8×16 and 16×8 block sizes additional NSPT kernels are trained with dimensionality 128×B1×C×D, while for 16×16 block sizes another additional NSPT kernel is trained with dimensionality 256×B2×C×D. The additional NSPT kernels are the same as the additional NSPT kernels available to the video encoder 100. In one embodiment of the invention, the parameters B1=32 and B2=32. In another embodiment of the invention, the parameters B1 may be set to values close to but not equal to 32, with the exact values selected according to empirical confirmation that a reference encoder complexity is not increased for these values.

In step S1370, the reconstruction module 1205 may generate a reconstructed CB by sample-wise summation of the reconstructed residual block and the prediction block. The video decoder 1100 may combine the reconstructed CB with other reconstructed CBs to produce the reconstructed picture or reconstructed sub-picture. After the filtering module 1206 has performed in-loop filtering to produce the decoded picture or decoded sub-picture, the video decoder 1100 may output the decoded picture or decoded sub-picture to the output video.

In summary, the video encoding method, the video decoding method, the video encoder, and the video decoder of the invention propose several methods for low complexity implementations of NSPT in video encoding and video decoding. The video encoding method, the video decoding method, the video encoder, and the video decoder of the invention can effectively improve coding performance for video coding by introducing larger NSPT kernels with complexity equivalent to corresponding LFNST kernels, novel zero-out policies for NSPT kernels, and/or extension of NSPT kernels to larger block sizes by implicit partitioning. The video encoding method, the video decoding method, the video encoder, and the video decoder of the invention can be used for future video coding standards.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

### REFERENCE SIGNS LIST

100: Video encoder
110, 1110: Processor
120, 1120: Storage device
130, 1130: Communication interface
140: Data bus
201: Partition module
202: Arithmetic module
203: Prediction module
204: Transform module
205: Quantization module
206: Entropy coding module
207: Inverse quantization module
208: Inverse quantization module
209: Reconstruction module
210: Filtering module
211: Decoded picture buffer module
400: Input picture
401: CTUs
402: CUs
1100: Video decoder
1201: Entropy decoding module
1202: Prediction module
1203: Inverse quantization module
1204: Inverse transform module
1205: Reconstruction module
1206: Filtering module
1207: Decoded picture buffer module
S310-S370, S1310-S1370: Step

1.-46. (canceled)

47. A video decoding method, comprising:
receiving an input bitstream;
determining a prediction block according to the input bitstream;
entropy decoding the input bitstream to obtain a plurality of quantized coefficients and a NSPT index;
inversely quantizing the plurality of quantized coefficients to generate a plurality of reconstructed coefficients;
in response to a current coding block (CB) having 8×16 block size, 16×8 block size or 16×16 block size, and the NSPT index having value 1, 2, or 3, executing an inverse non-separable primary transform (NSPT) on the plurality of reconstructed coefficients to generate a reconstructed residual block based on a kernel; and
generating a reconstructed CB according to the residual block and the prediction block.

48. The video decoding method according to claim 47, further comprising:
combining the reconstructed CB with a plurality of reconstructed CBs to generate the output video.

49. The video decoding method according to claim 47, wherein in response to a flag or set of flags indicating application of an intra prediction, the prediction block of the current CB is determined by intra prediction.

50. The video decoding method according to claim 47, wherein in response to the current CB having 8×16 block size or 16×8 block size, the inverse NSPT is executed using a NSPT transform matrix selected from a kernel with dimensionality 128×B1×C×D, wherein the parameter B1 is a number of transform coefficients produced by the NSPT from an encoder perspective, the parameter C is 3, and the parameter D is 35.

51. (canceled)

52. The video decoding method according to claim 47, wherein in response to the current CB having 16×16 block size, the inverse NSPT is executed using a NSPT transform matrix selected from a kernel with dimensionality 256×B2×C×D, wherein the parameter B2 is a number of transform coefficients produced by the NSPT from an encoder perspective, the parameter C is 3, and the parameter D is 35.

53. The video decoding method according to claim 50, wherein the parameter B1 is 32.

54.-56. (canceled)

57. The video decoding method according to claim 52, wherein the parameter B1 and the parameter B2 are 32.

58. (canceled)

59. The video decoding method according to claim 47, further comprising:
executing a zero-out on the residual block, so that the residual block after zero-out has a zero-out region.

60. The video decoding method according to claim 47, wherein in response to a size of the residual block being larger than a block size supported by a largest NSPT kernel, partitioning the residual block into a plurality of smaller transform blocks.

61. The video decoding method according to claim 60, wherein an NSPT index is signalled for each transform block in the plurality of smaller transform blocks.

62. The video decoding method according to claim 60, wherein a NSPT index is signalled for each unique transform block size, the transform blocks in the plurality of smaller transform blocks with same block size sharing a common NSPT index.

63. The video decoding method according to claim 47, wherein in response to a size of the residual block being larger than a block size supported by the largest NSPT kernel, the current CB is implicitly split into a plurality of smaller prediction blocks before prediction.

64. A video decoder, comprising a memory and a processor, wherein the memory is configured to store a computer program, and the processor is configured to execute the computer program stored in the memory to cause the video decoder to execute operations comprising:
receiving an input bitstream;
determining a prediction block according to the input bitstream;
entropy decoding the input bitstream to obtain a plurality of quantized coefficients and a NSPT index;
inversely quantizing the plurality of quantized coefficients to generate a plurality of reconstructed coefficients;
in response to a current coding block (CB) having 8×16 block size, 16×8 block size or 16×16 block size, and the NSPT index having value 1, 2, or 3, executing an inverse non-separable primary transform (NSPT) on the plurality of reconstructed coefficients to generate a reconstructed residual block based on a kernel; and
generating a reconstructed CB according to the residual block and the prediction block.

65. The video decoder according to claim 64, wherein the video decoder is further configured to: combine the reconstructed CB with a plurality of reconstructed CBs to generate the output video.

66. The video decoder according to claim 64, wherein in response to a flag or set of flags indicating application of an intra prediction, the prediction block of the current CB is determined by intra prediction.

67. The video decoder according to claim 64, wherein in response to the current CB having 8×16 block size or 16×8 block size, the inverse NSPT is executed using a NSPT transform matrix selected from a kernel with dimensionality 128×B1×C×D, wherein the parameter B1 is a number of transform coefficients produced by the NSPT from an encoder perspective, the parameter C is 3, and the parameter D is 35.

68. The video decoder according to claim 64, wherein in response to the current CB having 16×16 block size, the inverse NSPT is executed using a NSPT transform matrix selected from a kernel with dimensionality 256×B2×C×D, wherein the parameter B2 is a number of transform coefficients produced by the NSPT from an encoder perspective, the parameter C is 3, and the parameter D is 35.

69. The video decoder according to claim 67, wherein the parameter B1 is 32.

70. The video decoder according to claim 68, wherein the parameter B1 and the parameter B2 are 32.

71. A video encoding method, comprising:
receiving an input video and generating a plurality of coding blocks (CBs) of the input video;
generating a prediction block of a current CB;
calculating a residual block according to the current CB and the prediction block;
in response to the residual block having 8×16 block size, 16×8 block size or 16×16 block size, and a determined NSPT index having value 1, 2, or 3, executing a non-separable primary transform (NSPT) on the residual block to generate a plurality of coefficients based on a kernel;
quantizing the plurality of coefficients to generate a plurality of quantized coefficients;
encoding the plurality of quantized coefficients through entropy coding to an output bitstream; and
encoding the NSPT index to the output bitstream.
